(19) United States
(12) Patent Application Publication
(10) Pub. No.: US 2025/0288990 A1
(43) Pub. Date: Sep. 18, 2025

(54) MICROCHAMBER ARRAY AND METHOD FOR MANUFACTURING MICROCHAMBER ARRAY

(71) Applicant: Japan Display Inc., Tokyo (JP)

(72) Inventors: Toshihiko ITOGA, Tokyo (JP); Junko NAGASAWA, Tokyo (JP)

(73) Assignee: Japan Display Inc., Tokyo (JP)

(21) Appl. No.: 19/075,818

(22) Filed: Mar. 11, 2025

(30) Foreign Application Priority Data
Mar. 15, 2024 (JP) 2024-041705

(51) Int. Cl. B01L 3/00

(52) U.S. Cl. CPC B01L 3/502707; B01L 3/502715; B01L 2200/0689; B01L 2200/12

(57) ABSTRACT

A microchamber array includes: a first substrate; a second substrate facing the first substrate; a flow channel provided between the first substrate and the second substrate and through which a solvent containing a sample flows; a chamber body, which is provided on a surface of the first substrate and which faces the second substrate; and a plurality of storage parts provided in the chamber body. Further, the first substrate has a recess recessed from the surface of the first substrate in a thickness direction of the first substrate at a position overlapping each of the storage parts.

### CROSS-REFERENCE TO RELATED APPLICATION

This application claims the benefit of priority from Japanese Patent Application No. 2024-041705 filed on Mar. 15, 2024, the entire contents of which are incorporated herein by reference.

### BACKGROUND

### 1. Technical Field

The present disclosure relates to a microchamber array and a method for manufacturing the microchamber array.

### 2. Description of the Related Art

Japanese Patent Application Laid-open Publication No. 2015-40754 (JP-A-2015-40754) and WO 2014/034781 disclose high-density microchamber arrays (“microchamber array” in WO 2014/034781) including a flow channel through which a solvent containing a biological sample flows and a plurality of microchambers (“storage sections” in WO 2014/034781) that open into the flow channel.

The flow channels and the microchambers of the high-density microchamber arrays described in JP-A-2015-40754 and WO 2014/034781 are made of materials with conflicting properties, that is, hydrophobic material and hydrophilic material. However, when forming the microchambers (“storage sections” in WO 2014/034781), additives and resin components included in the material film (“chamber body” in WO 2014/034781) adhere to the bottom surfaces of the microchambers (“storage sections” in WO 2014/034781), and a hydrophilic solvent may possibly fail to be satisfactorily retained in the storage sections.

### SUMMARY

There is a need for providing a microchamber array and a method for manufacturing the microchamber array that can satisfactorily retain a hydrophilic solvent in storage parts.

According to an aspect, a microchamber array includes: a first substrate; a second substrate facing the first substrate; a flow channel provided between the first substrate and the second substrate and through which a solvent containing a sample flows; a chamber body, which is provided on a surface of the first substrate and which faces the second substrate; and a plurality of storage parts provided in the chamber body. Further, the first substrate has a recess recessed from the surface of the first substrate in a thickness direction of the first substrate at a position overlapping each of the storage parts.

According to an aspect, a method for manufacturing a microchamber array, includes: forming a chamber body on a first substrate; forming a plurality of storage parts in the chamber body; and glass etching a bottom surface of each of the storage parts with a cleaning solution after the forming of the storage parts.

According to an aspect, a method for manufacturing a microchamber array, includes: forming a light-shielding resin layer on a first substrate; forming a plurality of first openings in the light-shielding resin layer; stacking a water-repellent resin layer on the light-shielding resin layer; forming second openings at positions overlapping the respective first openings in the water-repellent resin layer; and glass etching a bottom surface of each of the first openings with a cleaning solution after the forming of the first openings and the second openings.

### BRIEF DESCRIPTION OF THE DRAWINGS

FIG. 1 is a plan view schematically illustrating a microchamber array according to a first embodiment;

FIG. 2 is a sectional view along line II-II′ of FIG. 1;

FIG. 3 is a view for explaining a state where solvents flow in a flow channel in the microchamber array according to the first embodiment;

FIG. 4 is a plan view schematically illustrating a configuration example of a plurality of storage parts of the microchamber array according to the first embodiment;

FIG. 5 is a sectional view along line V-V′ of FIG. 4;

FIG. 6 is a sectional view schematically illustrating a chamber body according to a first modification of the first embodiment;

FIG. 7 is a sectional view schematically illustrating the chamber body according to a first comparative example;

FIG. 8 is a view for explaining a method for manufacturing the microchamber array according to the first embodiment;

FIG. 9 is a view for explaining a method for manufacturing the microchamber array according to the first modification of the first embodiment; and

FIG. 10 is a graph illustrating time-series changes in the contact angle at the bottom surface of the storage part before and after glass etching in the method for manufacturing the microchamber array according to the first modification of the first embodiment.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below can be appropriately combined. What is disclosed herein is given by way of example only, and appropriate changes made without departing from the spirit of the present disclosure and easily conceivable by those skilled in the art naturally fall within the scope of the disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

When the term “on” is used to describe an aspect where a first structure is disposed on a second structure in the present specification and the claims, it includes both of the following cases unless otherwise noted: a case where the first structure is disposed directly on and in contact with the second structure, and a case where the first structure is disposed on the second structure with another structure interposed therebetween.

### First Embodiment

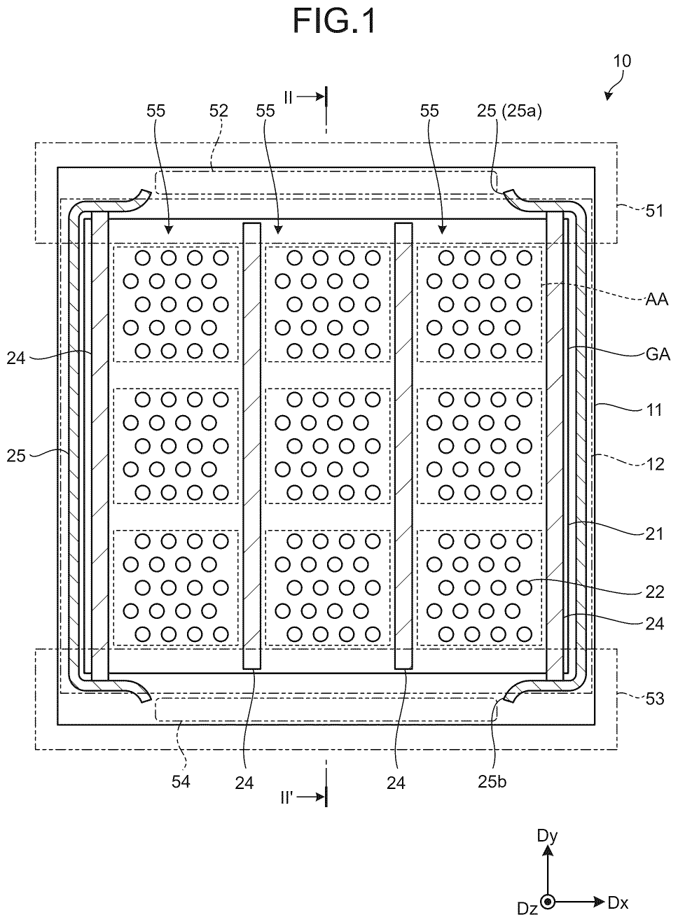

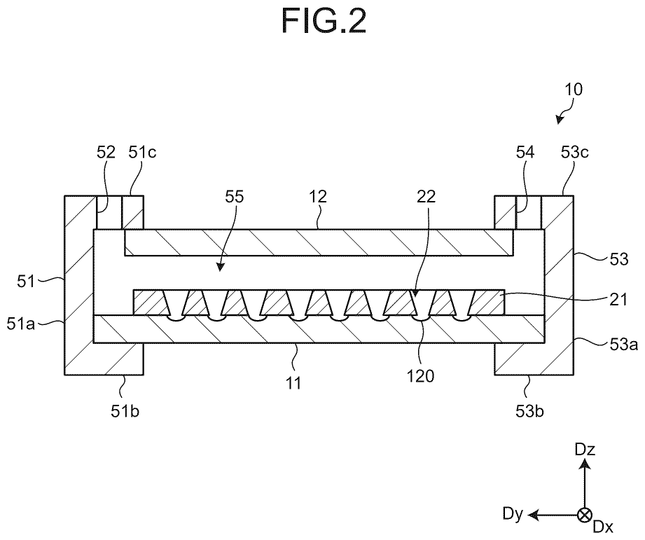

FIG. 1 is a plan view schematically illustrating a microchamber array according to a first embodiment. FIG. 2 is a sectional view along line II-II′ of FIG. 1. In FIG. 1, a second substrate 12, an injection jig 51, and a discharge jig 53 are represented by alternate long and two short dashes lines to make the drawing easier to see.

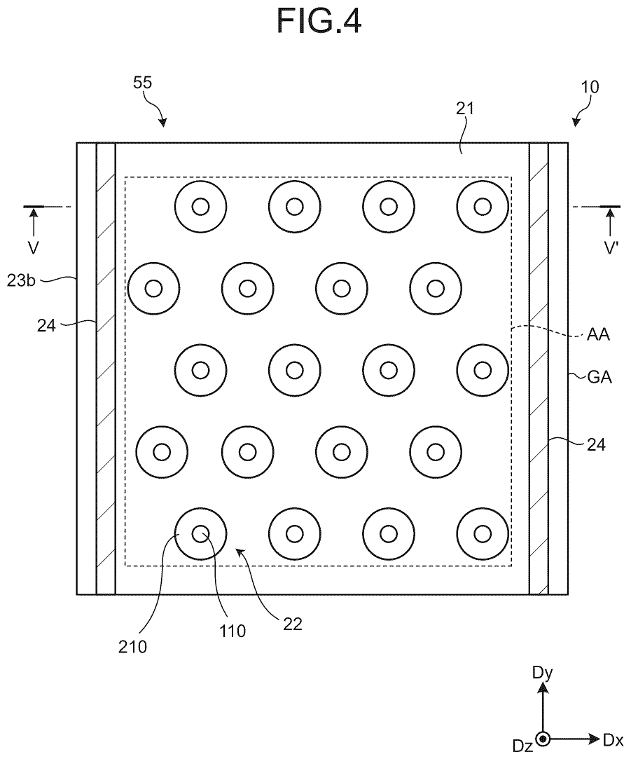

As illustrated in FIGS. 1 and 2, a microchamber array 10 includes a first substrate 11, the second substrate 12, a chamber body 21, a plurality of storage parts 22, a plurality of spacers 24, and a sealing part 25. While the storage parts 22 are not illustrated in FIGS. 1 to 3, the configuration of the storage parts 22 will be described later in greater detail with reference to FIG. 4.

The first substrate 11 is a flat plate-like member and is a glass substrate, for example. The second substrate 12 is disposed facing the first substrate 11 with a gap interposed therebetween. The second substrate 12 is a flat plate-like member and is a glass substrate, for example. The first substrate 11 and the second substrate 12 may be made of other materials, such as silicon and resin. To observe a sample accommodated in the storage parts 22, at least one of the first substrate 11 and the second substrate 12 is made of light-transmitting material.

As illustrated in FIG. 2, the chamber body 21 is provided on the surface of the first substrate 11, that is, the surface of the first substrate 11 facing the second substrate 12.

The chamber body 21 is a hydrophobic film and is made of water-repellent resin. The chamber body 21, for example, has a structure with its surface processed with a polymer film, such as resin containing a fluorine- or silicone-based component that controls surface energy, acrylic resin, epoxy resin, polyimide, polymer having a fluoroalkyl group on the side chain (e.g., a polymer of fluoroalkyl ethyl methacrylate and a copolymer of methacrylate), and polysiloxane (polymer having a hydrophobic methyl group or a highly hydrophobic fluoroalkyl group on the side chain of siloxane). More specifically, the chamber body 21 has a poor wettability with aqueous solutions and is highly water repellent. The chamber body 21 has a high affinity for oil.

The chamber body 21 has a storage part formation region AA and a peripheral region GA. The storage part formation region AA is a region where the storage parts 22 are formed. In the example illustrated in FIG. 1, a plurality of storage part formation regions AA are arranged in a matrix (row-column configuration) in the chamber body 21. The peripheral region GA is a region where the storage parts 22 are not formed. The peripheral region GA is provided between the storage part formation regions AA and on the side closer to the outer periphery of the chamber body 21 than the storage part formation regions AA.

In the following description, a first direction Dx is one direction in a plane parallel to the surface of the first substrate 11. A second direction Dy is one direction in the plane parallel to the surface of the first substrate 11 and is orthogonal to the first direction Dx. The second direction Dy may intersect the first direction Dx without being orthogonal thereto. A third direction Dz is a direction orthogonal to the first direction Dx and the second direction Dy. The third direction Dz is the direction normal to the surface of the first substrate 11. The term “plan view” refers to the positional relation when viewed from a direction perpendicular to the surface of the first substrate 11.

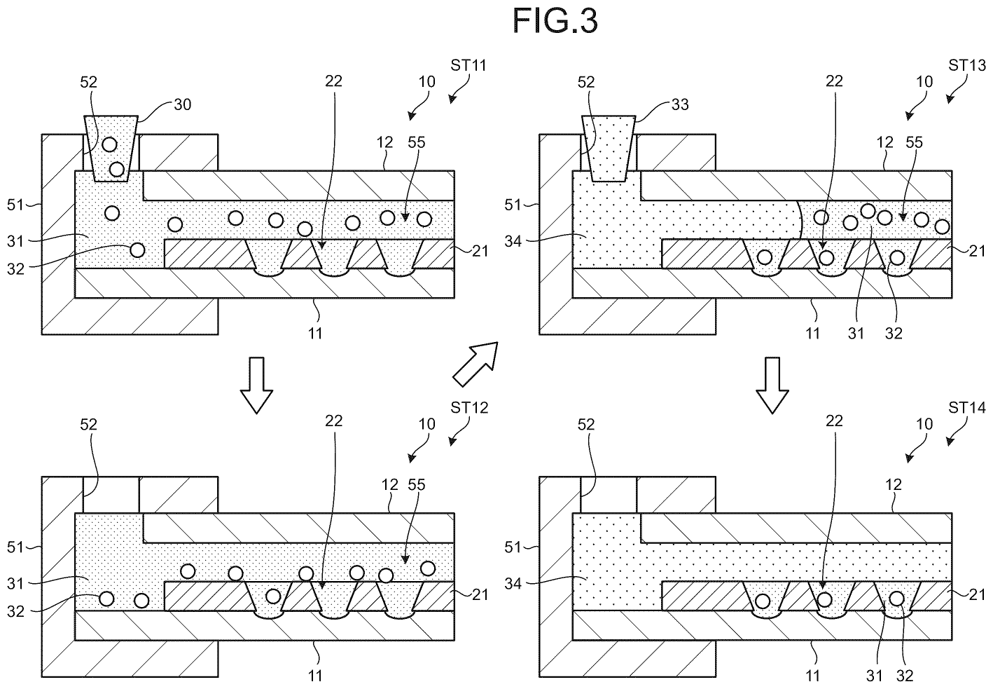

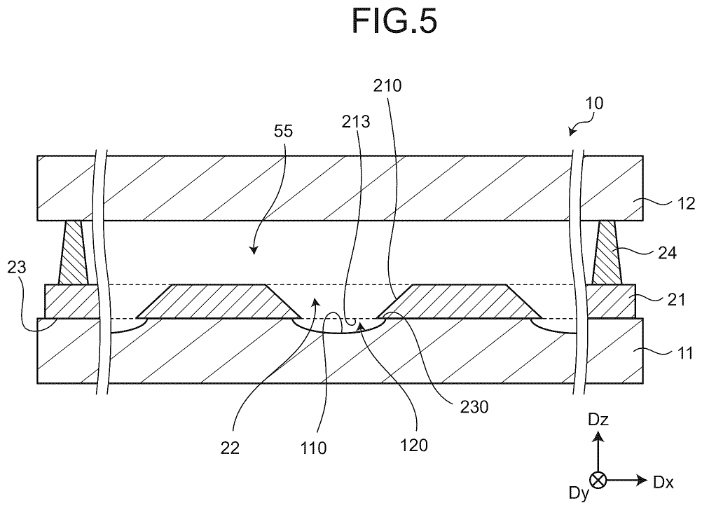

As illustrated in FIG. 2, the storage parts 22 are formed in the chamber body 21, serve as spaces for accommodating a solvent 31 (refer to FIG. 3) containing a sample to be detected, and are also called minute chambers or microchambers. The storage parts 22 are formed through the chamber body 21 in the thickness direction. The inner walls of the storage parts 22 are composed of the material of the chamber body 21. Bottom surfaces 110 of the respective storage parts 22 are composed of the surface of the first substrate 11, that is, glass, for example. The glass is more hydrophilic than the chamber body 21. In other words, the bottom surfaces 110 of the storage parts 22 are more hydrophilic than the surface of the chamber body 21. The bottom surface 110 of each storage part 22 has a recess 120. The recess 120 also accommodates the solvent 31 similarly to the storage part 22. The configuration of the recess 120 will be described later in greater detail with reference to FIG. 5.

As illustrated in FIG. 1, the spacers 24 are wall-like members provided in the peripheral region GA of the chamber body 21. The spacers 24 are arrayed in the first direction Dx and each extend in the second direction Dy. A plurality of storage part formation regions AA are arrayed in the second direction Dy between the spacers 24 adjacently disposed in the first direction Dx. The upper ends of the spacers 24 are in contact with the second substrate 12 (refer to FIG. 5). Thus, the distance between the chamber body 21 and the second substrate 12 in the third direction Dz is defined.

With this configuration, a flow channel 55 through which solvents 31 and 34 (refer to FIG. 3) flow from an inlet 52 to an outlet 54 is formed between the first substrate 11 and the second substrate 12 and between the spacers 24 in plan view. In the example illustrated in FIG. 1, there are three flow channels 55 separated by the spacers 24, and the three flow channels 55 each extend along the second direction Dy. The inlet 52 into which the solvent 31 is injected is formed on one side of the flow channel 55 in the second direction Dy, and the outlet 54 from which the solvent 31 is discharged is formed on the other side of the flow channel 55 in the second direction Dy.

The sealing part 25 is a member that bonds the first substrate 11 and the second substrate 12 and is provided to the part of the first substrate 11 closer to the outer periphery than the chamber body 21. The sealing part 25 is provided along the sides of the first substrate 11 extending in the second direction Dy. The sealing part 25 has a first opening 25a on the side corresponding to the inlet 52 and a second opening 25b on the side corresponding to the outlet 54 on the opposite side of the first opening 25a.

As illustrated in FIG. 2, the injection jig 51 is provided to cover one end of the first substrate 11 and the second substrate 12 in the second direction Dy. The discharge jig 53 is provided on the opposite side of the injection jig 51 to cover the other end of the first substrate 11 and the second substrate 12 in the second direction Dy. The injection jig 51 and the discharge jig 53 have first portions 51a and 53a, second portions 51b and 53b, and third portions 51c and 53c, respectively. The first portions 51a and 53a extend in the third direction Dz and are provided to cover the gap between the first substrate 11 and the second substrate 12. The second portions 51b and 53b are provided overlapping part of the back surface of the first substrate 11. The third portions 51c and 53c are provided overlapping part of the surface of the second substrate 12.

The third portion 51c of the injection jig 51 has the inlet 52 passing therethrough in the third direction Dz. The third portion 51c of the discharge jig 53 has the outlet 54 passing therethrough in the third direction Dz. The length of the second substrate 12 in the second direction Dy is shorter than that of the first substrate 11 in the second direction Dy. The inlet 52 of the injection jig 51 and the outlet 54 of the discharge jig 53 are each formed in a region not overlapping the second substrate 12. With this configuration, the inlet 52, the flow channel 55, and the outlet 54 communicate with each other.

FIG. 3 is a view for explaining a state where the solvents flow in the flow channel in the microchamber array according to the first embodiment. Each figure in FIG. 3 is an enlarged sectional view of a part of the microchamber array 10 near the inlet 52.

As illustrated in FIG. 3, a solvent supplier 30 (nozzle) is inserted into the inlet 52, and the solvent 31 is injected from the inlet 52 into the flow channel 55 (Step ST11). The solvent 31 is a hydrophilic solvent containing a sample to be detected (not illustrated) and a reagent 32. Examples of the hydrophilic solvent include, but are not limited to, water, hydrophilic alcohol (specifically, those with a small hydrocarbon number, such as methanol, ethanol, and IPA), hydrophilic ether, ketone, nitrile solvent, dimethyl sulfoxide, N, N-dimethylformamide ionic solution, N, N-dimethylformamide electrolyte solution, etc. The sample to be detected is, for example, a biomolecule or a virus. The reagent 32 is material that reacts with the sample.

Subsequently, the solvent supplier 30 is removed, and the microchamber array 10 is left for a certain period of time (Step ST12). The reagent 32 settles in the solvent 31 and is placed on the chamber body 21. Part of the reagent 32 is accommodated in the storage parts 22 together with the solvent 31 containing the sample to be detected.

Subsequently, a solvent supplier 33 (nozzle) is inserted into the inlet 52, and the solvent 34 is injected from the inlet 52 into the flow channel 55 (Step ST13). The solvent 34 is a hydrophobic solvent. Examples of the hydrophobic solvent include, but are not limited to, straight-chain saturated hydrocarbon such as n-hexadecane, cyclic saturated hydrocarbon such as cyclohexane, unsaturated hydrocarbon, aromatic hydrocarbon, silicone oil, perfluorocarbon, halogen-based solvent, etc. The solvent 34 is injected to push the solvent 31 and the reagent 32 injected at Steps ST11 and ST12 toward the outlet 54. As a result, the reagent 32 is accommodated in the storage parts 22.

Subsequently, the solvent 34 is filled into the flow channel 55 to cover the storage parts 22, and the solvent supplier 33 is removed (Step ST14). The storage parts 22 each accommodate the solvent 31 containing the sample to be detected and the reagent 32. The solvent 31 containing the sample to be detected and the reagent 32 accommodated in the storage parts 22 is covered with the solvent 34.

As described above, at least the bottom surfaces 110 of the storage parts 22 are hydrophilic, and the chamber body 21 is hydrophobic. In other words, the bottom surfaces 110 of the storage parts 22 are highly hydrophilic and have a high affinity for the solvent 31 containing the sample to be detected and the reagent 32. Therefore, the solvent 31 containing the reagent 32 is placed in contact with the bottom surfaces 110. By contrast, the surface of the chamber body 21 is in contact with the solvent 34 because it has a high affinity for oil and has a high affinity for the solvent 34 that covers the storage parts 22. Therefore, the solvent 31 containing the sample to be detected and the reagent 32 is efficiently accommodated in each of the storage parts 22 at Step ST14. The microchamber array 10 can detect whether the sample is present in each of the storage parts 22 by observing fluorescence from the sample sealed in each of the storage parts 22 from the back surface side of the first substrate 11.

While the space between the first substrate 11 and the second substrate 12 according to the present embodiment is filled with the solvent 31, the method for sealing the solvent 31 in the microchamber array 10 is not limited to this method. For example, the solvent 31 (aqueous solution specimen) containing the reagent 32 may be dripped on the first substrate 11 and sealed by the solvent 34 (oil) placed over the solvent 31.

The following describes the configuration of the storage parts 22 formed in the storage part formation region AA in greater detail. FIG. 4 is a plan view schematically illustrating a configuration example of the storage parts of the microchamber array according to first embodiment. FIG. 5 is a sectional view along line V-V′ of FIG. 4.

As illustrated in FIG. 4, the storage parts 22 each have a circular shape in plan view and are arranged in a triangular lattice in the storage part formation region AA. In other words, the storage parts 22 are arranged such that the positions of the storage parts 22 in the n-th column arrayed in the second direction Dy are shifted from the positions of the storage parts 22 in the n+1-column arrayed in the second direction Dy.

The arrangement, the number, and the like of the storage parts 22 illustrated in FIG. 4 are given by way of example only and can be changed as appropriate. The arrangement of the storage parts 22 is not limited to a triangular shape and may be one of rectangular and rhombic shapes.

As illustrated in FIG. 5, the bottom surface 110 of each storage part 22 has the recess 120 recessed from the surface of the first substrate 11 in the thickness direction of the first substrate 11. The storage part 22 has a side surface 210 and is forward tapered. The recess 120 has an arc shape, for example.

An opening plane 230 of the recess 120 is formed at a position overlapping an opening plane 213 on a surface 23 of the storage part 22 where the chamber body 21 and the surface of the first substrate 11 are in contact.

This can facilitate retaining the sample of the specimen in the storage part 22.

The opening plane 230 of the recess 120 is wider than the opening diameter of the opening plane 213 on the surface 23 of the storage part 22 where the chamber body 21 and the first substrate 11 are in contact. This makes the surface tension on the first substrate 11 higher, thereby facilitating retaining the sample of the specimen in the storage part 22.

The injection jig 51 and the discharge jig 53 may be provided integrally with the first substrate 11 and the second substrate 12 by a fixing member, which is not illustrated. Alternatively, the injection jig 51 and the discharge jig 53 may be provided removably from the first substrate 11 and the second substrate 12 as needed.

### First Modification of the First Embodiment

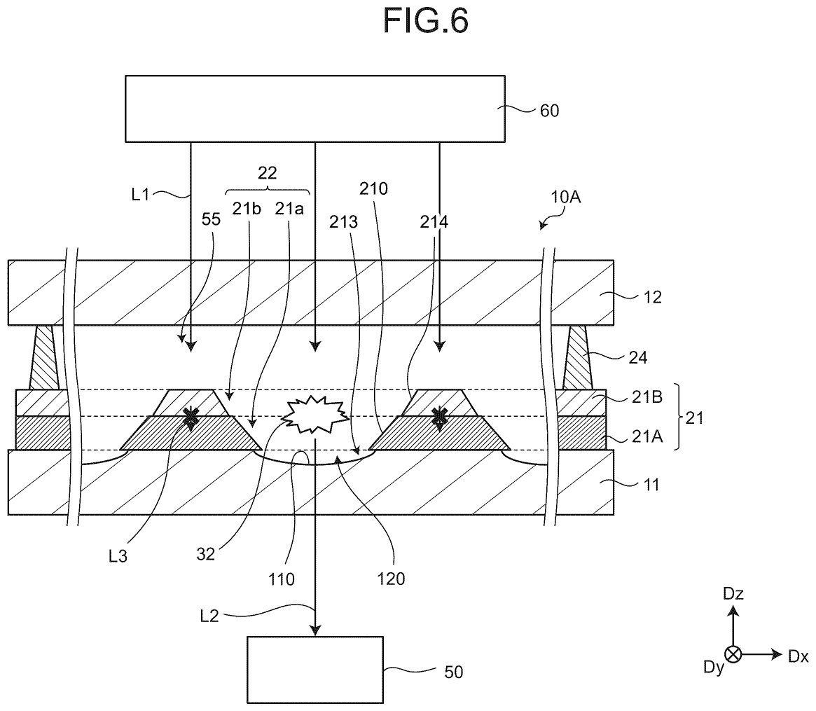

FIG. 6 is a sectional view schematically illustrating the microchamber array according to a first modification of the first embodiment. As illustrated in FIG. 6, in a microchamber array 10A according to the first modification of the first embodiment, in the following description, the same components as those described in the embodiment above are denoted by like reference numerals, and duplicated explanation is omitted.

As illustrated in FIG. 6, in a microchamber array 10A according to a first modification of the first embodiment, the chamber body 21 includes a light-shielding resin layer 21A and a water-repellent resin layer 21B. The light-shielding resin layer 21A and the water-repellent resin layer 21B are stacked in order on the first substrate 11. The water-repellent resin layer 21B is made of black resin material. The water-repellent resin layer 21B may be made of resin that does not emit light.

The storage parts 22 each have a first opening 21a formed in the light-shielding resin layer 21A and a second opening 21b formed in the water-repellent resin layer 21B. The first opening 21a is formed through the light-shielding resin layer 21A in the thickness direction, and the second opening 21b is formed through the water-repellent resin layer 21B in the thickness direction.

The bottom surface 110 of each first opening 21a has the recess 120.

As illustrated in FIG. 6, the microchamber array 10A includes a light source 60 that outputs excitation light L1 and a detection circuit 50.

The detection circuit 50 is a charge coupled device and serves as an imaging circuit. The detection circuit 50 can detect the intensity of fluorescence and the emission intensity distribution of fluorescence.

The light source 60 outputs the excitation light L1 to the upper surface of the chamber body 21. The detection circuit 50 detects fluorescence L2 emitted by the sample in the storage part 22 due to the excitation light L1. At this time, the water-repellent resin layer 21B emits autofluorescence L3 due to the excitation light L1. The light-shielding resin layer 21A can reduce the autofluorescence L3 emitted by the water-repellent resin layer 21B. As a result, the autofluorescence L3 emitted by the water-repellent resin layer 21B is less likely to be detected by the detection circuit 50. This configuration improves the detection accuracy of the detection circuit 50 detecting the fluorescence L2 emitted by the sample in the storage part 22 due to the excitation light L1.

As illustrated in FIG. 6, the first opening 21a and the second opening 21b have side surfaces 210 and 214, respectively, and the side surface 210 of the first opening 21a and the side surface 214 of the second opening 21b are forward tapered. The inner diameter of the second opening 21b is larger than that of the first opening 21a. The inner diameter of the first opening 21a corresponds to the diameter of the bottom surface of the second opening 21b, that is, the diameter of the opening plane 213 of the recess 120. The inner diameter of the second opening 21b corresponds to the diameter of the opening plane where the first opening 21a and the second opening 21b are in contact.

With this configuration, the autofluorescence L3 emitted by the water-repellent resin layer 21B is reduced by the light-shielding resin layer 21A and is less likely to be detected by the detection circuit 50. Therefore, this configuration can increase the SNR of detecting the fluorescence of the sample and improve the detection accuracy.

In the first embodiment, the fluorescence L2 of the sample is detected by irradiating the chamber body 21 with the excitation light L1. Alternatively, a reflective detection method may be employed in which the fluorescence L2 of the sample is detected by irradiating the lower surface of the chamber body 21 with the excitation light L1. As described above, the autofluorescence generated when the light-shielding resin layer 21A is irradiated with the excitation light L1 is smaller than the autofluorescence L3 generated when the water-repellent resin layer 21B is irradiated with the excitation light L1. Therefore, the amount of autofluorescence L3 generated when the upper surface of the chamber body 21 is irradiated with the excitation light is smaller than that of autofluorescence L3 generated when the lower surface of the chamber body 21 is irradiated with the excitation light. Thus, the autofluorescence L3 in the water-repellent resin layer 21B is less likely to be detected by the detection circuit 50 also in the reflective detection method. The chamber body 21 may be irradiated with the excitation light L1 from the light source 60 without the second substrate provided thereon.

### First Comparative Example of the First Embodiment

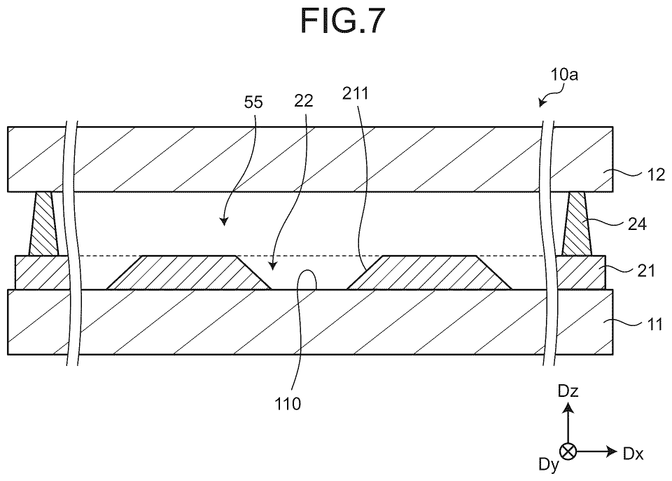

FIG. 7 is a sectional view schematically illustrating a configuration example of the storage parts of the microchamber array according to a first comparative example.

As illustrated in FIG. 7, in a microchamber array 10a according to the first comparative example, the storage part 22 of the chamber body 21 does not have the recess 120. In this configuration, additives and resin components included in a resin molded product adhere to the glass surface, that is, the bottom surface 110 of the storage part 22 when forming the storage part in the resin molded product on the glass. As a result, a hydrophilic solvent may possibly fail to be satisfactorily retained in the storage part.

By contrast, in the microchamber array 10 according to the first embodiment, the recesses 120 are formed at the positions overlapping the storage parts 22 on the surface of the first substrate 11. This can facilitate retaining the sample of the specimen in the storage parts.

### Method for Manufacturing a Detection Device 1 According to the Embodiment

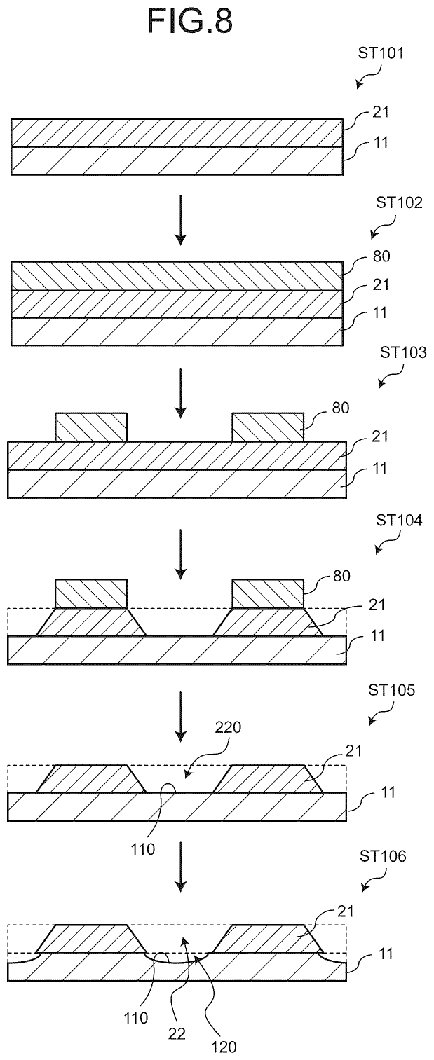

The following describes a method for manufacturing a detection device 1. FIG. 8 is a view for explaining the method for manufacturing the microchamber array according to the first embodiment.

As illustrated in FIG. 8, in the method for manufacturing the detection device 1, the chamber body 21 is formed on the first substrate 11 (Step ST101).

Next, a resist layer 80 is stacked on the chamber body 21 (Step ST102).

Next, the resist layer 80 is subjected to photoetching and is exposed and developed using a photomask with a predetermined pattern, and the predetermined pattern is removed (Step ST103).

Next, part of the chamber body 21 the surface of which is exposed is removed by photoetching (Step ST104).

Then, the resist layer 80 remaining on the chamber body 21 is peeled off, and the chamber body 21 is patterned to form a plurality of storage parts 22 in the chamber body 21 (Step ST105).

Finally, the bottom surface 110 of the storage part 22 is subjected to glass etching with a cleaning solution (Step ST106). As a result, the bottom surface 110 of the storage part 22 is eroded to form the recess 120, thereby facilitating retaining the specimen of the aqueous solution.

Examples of the cleaning solution include, but are not limited to, dilute hydrofluoric acid, alkaline glass cleaning solution, etc. If the cleaning solution is an alkaline glass cleaning solution, for example, it may be at least one of the following: Semico Clean 56, GC-3022 FT, PK-LCG series, SUNECON AS-3, and Semiclean series.

As a result, deposits composed of the resin components or the like of the chamber body 21 and adhering to the bottom surface 110 are removed from the bottom surface 110 by lift-off. Therefore, the contact angle of the bottom surface 110 to water is 10° (degrees) or smaller, and the wettability of the bottom surface 110 can be improved.

The cleaning solution may be an organic solvent. While the organic solvent has no etching action, it can dissolve the deposits adhering to the bottom surface 110 and improve the wettability of the bottom surface 110.

### First Modification of the Method for Manufacturing the Detection Device 1

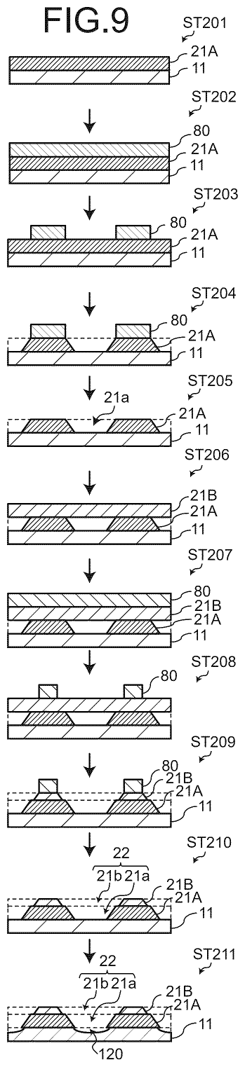

The following describes the first modification of the method for manufacturing the detection device 1 mainly focusing on the differences from the method for manufacturing the detection device 1 described above. FIG. 9 is a view for explaining the method for manufacturing the microchamber array according to the first modification of the first embodiment. In the following description, the same components as those described in the method for manufacturing the detection device 1 above are denoted by like reference numerals, and duplicated explanation is omitted.

As illustrated in FIG. 9, the light-shielding resin layer 21A is formed on the first substrate 11 (Step ST201).

Next, the resist layer 80 is stacked on the light-shielding resin layer 21A (Step ST202).

Next, the resist layer 80 is subjected to photoetching and is exposed and developed using a photomask with a predetermined pattern, and the predetermined pattern is removed (Step ST203).

Next, part of the light-shielding resin layer 21A the surface of which is exposed is removed by photoetching (Step ST204).

Then, the resist layer 80 remaining on the light-shielding resin layer 21A is peeled off, and the light-shielding resin layer 21A is patterned to form a plurality of first openings 21a in the light-shielding resin layer 21A (Step ST205).

Next, the water-repellent resin layer 21B is stacked on the light-shielding resin layer 21A (Step ST206).

Next, the resist layer 80 is stacked on the water-repellent resin layer 21B (Step ST207).

Next, the resist layer 80 is subjected to photoetching and is exposed and developed using a photomask with a predetermined pattern, and the predetermined pattern is removed (Step ST208).

Next, part of the water-repellent resin layer 21B the surface of which is exposed is removed by photoetching (Step ST209).

Then, the resist layer 80 remaining on the water-repellent resin layer 21B is peeled off, and the water-repellent resin layer 21B is patterned to form a plurality of second openings 21b in the water-repellent resin layer 21B at the positions overlapping the respective first openings 21a (Step ST210). Thus, a plurality of storage parts 22 having the first opening 21a and the second opening 21b are formed.

Finally, the bottom surface 110 of the first opening 21a is subjected to glass etching with a cleaning solution (Step ST211). As a result, the bottom surface 110 of the storage part 22 is eroded to form the recess 120, thereby facilitating retaining the specimen of the aqueous solution.

Thus, deposits composed of the resin components or the like of the light-shielding resin layer 21A and the water-repellent resin layer 21B and adhering to the bottom surface 110 are removed from the bottom surface 110 by lift-off. Therefore, the contact angle of the bottom surface 110 to water is 10° or smaller, and the wettability of the bottom surface 110 can be improved.

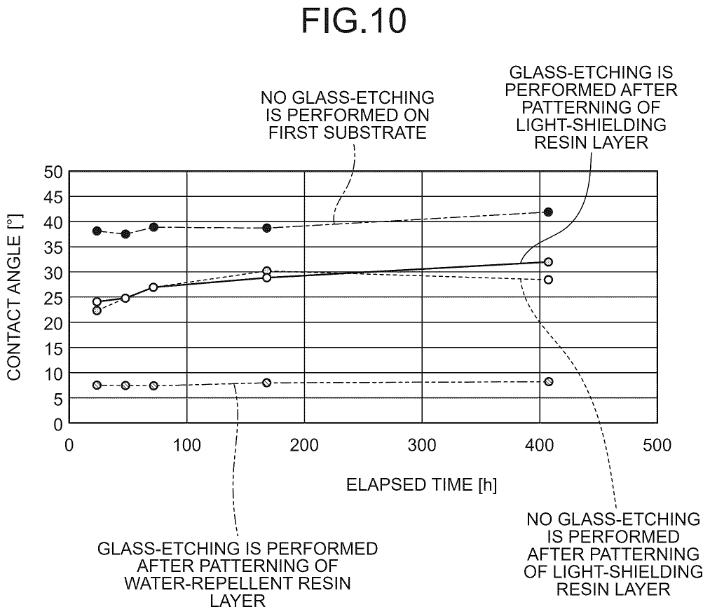

FIG. 10 is a view for explaining time-series changes in the contact angle at the bottom surface of the storage part before and after glass etching process in the method for manufacturing the microchamber array according to the first modification of the first embodiment. The explanatory diagram illustrated in FIG. 10 indicates the results obtained when dilute hydrofluoric acid is used as the cleaning solution in glass etching.

As illustrated in FIG. 10, if glass etching is not performed on the surface of the first substrate 11, the contact angle of the bottom surface 110 to water is approximately 37° and increases by approximately 5° as time passes after glass etching. Thus, there is no effect of the glass etching action.

If glass etching is performed after the light-shielding resin layer 21A is patterned, the contact angle of the bottom surface 110 to water is approximately 25° and increases by approximately 5° as time passes after glass etching. Thus, there is no effect of the glass etching action. The same applies to the case where glass etching is not performed after the light-shielding resin layer 21A is patterned.

If glass etching is performed after the water-repellent resin layer 21B is patterned, the contact angle of the bottom surface 110 to water is approximately 8° and is substantially constant over time after glass etching. Thus, the effect of the glass etching action can be maintained. If glass etching is performed on the surface of the water-repellent resin layer 21B, the contact angle of the surface of the water-repellent resin layer 21B to water is 63° and increases to 11° as time passes after glass etching because the deposits on the surface of the water-repellent resin layer 21B are removed.

While exemplary embodiments according to the present disclosure have been described, the embodiments are not intended to limit the disclosure. The contents disclosed in the embodiments are given by way of example only, and various modifications can be made without departing from the spirit of the present disclosure. Appropriate modifications made without departing from the spirit of the present disclosure naturally fall within the technical scope of the disclosure. At least one of various omissions, substitutions, and modifications of the components can be made without departing from the gist of the embodiments and modifications described above.

What is claimed is:

1. A microchamber array comprising:
a first substrate;
a second substrate facing the first substrate;
a flow channel provided between the first substrate and the second substrate and through which a solvent containing a sample flows;
a chamber body, which is provided on a surface of the first substrate and which faces the second substrate; and
a plurality of storage parts provided in the chamber body, wherein
the first substrate has a recess recessed from the surface of the first substrate in a thickness direction of the first substrate at a position overlapping each of the storage parts.

2. The microchamber array according to claim 1, wherein
the chamber body includes a water-repellent resin layer and a light-shielding resin layer, and
the light-shielding resin layer and the water-repellent resin layer are stacked in order on the first substrate.

3. A method for manufacturing a microchamber array, comprising:
forming a chamber body on a first substrate;
forming a plurality of storage parts in the chamber body; and
glass etching a bottom surface of each of the storage parts with a cleaning solution after the forming of the storage parts.

4. A method for manufacturing a microchamber array, comprising:
forming a light-shielding resin layer on a first substrate;
forming a plurality of first openings in the light-shielding resin layer;
stacking a water-repellent resin layer on the light-shielding resin layer;
forming second openings at positions overlapping the respective first openings in the water-repellent resin layer; and
glass etching a bottom surface of each of the first openings with a cleaning solution after the forming of the first openings and the second openings.

5. The method for manufacturing a microchamber array according to claim 3, wherein the cleaning solution is dilute hydrofluoric acid.

6. The method for manufacturing a microchamber array according to claim 4, wherein the cleaning solution is dilute hydrofluoric acid.

7. The method for manufacturing a microchamber array according to claim 3, wherein the cleaning solution is at least one of Semico Clean 56, GC-3022 FT, PK-LCG series, SUNECON AS-3, and Semiclean series.

8. The method for manufacturing a microchamber array according to claim 4, wherein the cleaning solution is at least one of Semico Clean 56, GC-3022 FT, PK-LCG series, SUNECON AS-3, and Semiclean series.
